(19) United States
(12) Patent Application Publication
(10) Pub. No.: US 2013/0330580 A1
(43) Pub. Date: Dec. 12, 2013

(54) SEALED BATTERY

(71) Applicants: Mayumi Yamamoto, Ibaraki-shi (JP); Hiroshi Maesono, Ibaraki-shi (JP); Soichi Watari, Ibaraki-shi (JP); Akino Isa, Ibaraki-shi (JP)

(72) Inventors: Mayumi Yamamoto, Ibaraki-shi (JP); Hiroshi Maesono, Ibaraki-shi (JP); Soichi Watari, Ibaraki-shi (JP); Akino Isa, Ibaraki-shi (JP)

(73) Assignee: HITACHI MAXELL, LTD., Ibaraki-shi, Osaka (JP)

(21) Appl. No.: 14/000,460

(22) PCT Filed: Nov. 1, 2011
(86) PCT No.: PCT/JP2011/075181

§ 371 Date: Aug. 20, 2013

(51) Int. Cl. H01M 2/12

(52) U.S. Cl. CPC H01M 2/1294
USPC 429/54

(57) ABSTRACT

A sealed battery with a cleavage groove is provided. A cleavage groove (41) is provided on a flat section (13) of the battery case (2) to form a cleavage line intersecting a ridge line (L) formed on the flat section of the battery case when the battery case swells up due to an increase in internal pressure. The cleavage line is, as viewed in a side view, a curved line made up of a first curved segment (42) curved to protrude in one direction and a second curved segment (43) curved to protrude in a direction forming an angle of 90 degrees or larger with the direction in which the first curved segment protrudes, the first and second curved segments being connected with each other. At least one of the first curved segment and the second curved segment intersects the ridge line.

### TECHNICAL FIELD

The present invention relates to a sealed battery having a cleavage groove formed on a side of a battery case encapsulating an electrode assembly and electrolyte, the cleavage groove configured to cleave up when the pressure in the battery case exceeds a threshold.

### BACKGROUND ART

Sealed batteries with a cleavage groove formed on a side of the battery case that is configured to cleave up when the pressure in the battery case exceeds a threshold are known. As disclosed in Japanese Patent No. 4166028, for example, such a sealed battery includes a cleavage groove located on a side of the battery case to intersect a raised ridge (i.e. a ridge line), which is formed when the battery case swells up due to an increase in internal pressure. Thus, when the pressure in the battery case exceeds a threshold, the battery case is deformed to cause the cleavage groove to cleave up, which releases gas or the like in the battery case to the outside.

### DISCLOSURE OF THE INVENTION

If a cleavage groove is provided on a side of the battery case, as in Japanese Patent No. 4166028, the cleavage groove may cleave up due to an impact given to the battery case if the battery falls, for example. In such a case, electrolyte in the battery case may leak out.

In view of this, the cleavage line formed by the cleavage groove may be shaped such that the groove is unlikely to cleave up when the battery falls, for example. However, if a cleavage line is thus shaped, the cleavage groove may not cleave up even when the pressure in the battery case exceeds a threshold.

Further, the cleavage line is preferably shaped such that the cleavage groove opens up as widely as possible when it cleaves up in order to release gas effectively from within the battery case. However, if the area where a cleavage is generated is increased to form a relatively large opening, some cleaved portions may get in contact with the electrode assembly in the battery case to cause a short circuit, or may damage an exterior film that covers the battery case.

In view of this, a sealed battery with a cleavage groove formed on a side of a battery case encapsulating an electrode assembly and electrolyte should be provided, where the cleavage groove is less likely to cleave up even when receiving an impact if the battery falls, for example, while being able to cleave up safely and easily in response to a certain pressure in the battery case.

A sealed battery according to an embodiment of the present invention includes a columnar battery case configured to encapsulate an electrode assembly and electrolyte, wherein a side of the battery case includes a cleavage groove forming a cleavage line intersecting a ridge line which is formed on the side of the battery case when the battery case swells up due to an increase in internal pressure, the cleavage line is, as viewed in a direction normal to the side of the battery case, a curved line formed of a first curved segment curved to protrude in one direction and a second curved segment curved to protrude in a direction forming an angle of 90 degrees or larger with the direction in which the first curved segment protrudes, the first and second curved segments being connected with each other, and at least one of the first curved segment and the second curved segment intersects the ridge line (first arrangement).

In the above arrangement, the cleavage line formed by the cleavage groove is a curved line, allowing the cleavage groove to cleave up more easily than in implementations where the cleavage line is a straight line. Further, the cleavage line includes, as viewed in a direction normal to the side of the battery case, a first curved segment curved to protrude in one direction and a second curved segment curved to protrude in a direction forming an angle of 90 degrees or larger with the direction in which the first curved segment protrudes, allowing the cleavage groove to cleave up more easily than that in a simply arc-shaped cleavage line.

Furthermore, as the cleavage line is shaped in the above manner, the cleavage groove is less likely to cleave up due to an impact given to the battery case. More specifically, a cleavage groove in a straight line may cleave up in one stroke when there is an external impact in a direction coinciding with an extension of the direct line; however, the above arrangement will prevent cleaving due to an external impact in a certain direction. Thus, the above arrangement will prevent the cleavage groove from cleaving up due to an impact given to the battery case and thereby preventing electrolyte in the battery from leaking out.

Further, as the cleavage line is formed by combining the first and second curved segments, when the cleavage groove cleaves up along the cleavage line, the protrusion formed by the first curved segment and the protrusion formed by the second curved segment protrude outward with respect to the battery case. This will increase the size of the opening formed as the cleavage groove cleaves up, allowing gas or the like in the battery to be released effectively to the outside through the cleavage. Moreover, in the above arrangement, the protrusions formed as the cleavage groove cleaves up are located outside the battery case, thereby preventing a short circuit between the interior of the battery and the battery case near the cleavage.

Further, as the cleavage line is formed by combining the first and second curved segments, the size of the protrusions formed by a cleavage may be reduced compared with a protrusion resulting from an arc shaped cleavage line of the same length as that of the present cleavage line. This will prevent more reliably a short circuit between the interior of the battery and the battery case via the protrusions formed by a cleavage, while preventing the exterior film or the like covering the battery case from being damaged by the protrusions.

In the first arrangement above, it is preferable that the cleavage line is formed of a combination of a single first curved segment and a single second curved segment (second arrangement).

Thus, a cleavage groove forming a cleavage line in a simple shape (S-shape, for example) can cleave up more easily when the battery case is deformed and, after the cleavage groove cleaves up, a relatively large opening can be easily created.

In the first or second arrangement above, it is preferable that the first curved segment is curved to protrude toward an edge of the battery case located at a base end of the ridge line intersecting the cleavage line, and the cleavage groove is formed on the side of the battery case such that the first curved segment is located on the ridge line (third arrangement).

Thus, the protrusion of the first curved segment is located closer to the end of the battery case as measured on the ridge line such that the first curved segment, which is located on the ridge line, can easily cleave up as the battery case is deformed. More specifically, as the battery case is deformed, a ridge line is generated beginning from the area near the end of the battery case; in view of this, having the first curved segment curved to protrude toward that end will allow the first curved segment to cleave up early during deformation of the battery case. Thus, the cleavage groove can cleave up in a more reliable manner as the battery case is deformed.

In any one of the first to third arrangements, it is preferable that a cleavage groove is provided on each of a pair of opposite sides of the battery case (fourth arrangement).

Thus, as the battery case is deformed, one of the cleavage grooves formed on a pair of sides cleaves up. Thus, even when the pressure in the battery case exceeds a threshold but the cleavage groove on one side does not cleave up, the cleavage groove on the other side may cleave up, meaning that the pressure in the battery case may be prevented from increasing in a more reliable manner.

In the fourth arrangement, the cleavage line on one of the pair of sides, as viewed in a direction normal to the one side, intersects a ridge line formed on the one side in one of halves of the battery case disposed in a width direction thereof and is located adjacent one of edges of the battery case disposed in an axial direction thereof, while the cleavage line on the other one of the pair of sides, as viewed in a direction normal to the one side, intersects a ridge line formed on the other side in the other one of the halves of the battery case disposed in a width direction thereof and is located adjacent the other one of the edges of the battery case disposed in an axial direction thereof (fifth arrangement).

Thus, the cleavage grooves formed on a pair of sides are located in diagonal positions on the battery case as viewed in a direction normal to one side of the battery case. Thus, even when there are variations in the strength of the sides of the battery case as measured in a width direction or in a vertical direction, leading to variations in the deformation of the sides as measured in a width direction or in a vertical direction, one of the cleavage grooves on the pair of sides cleaves up. Thus, increase in the pressure in the battery case is prevented in a more reliable manner.

In any one of the first to fifth arrangements, it is preferable that the battery case is a column having a rectangular bottom surface with an arc-like short side and having a space capable of containing the electrode assembly and the electrolyte (sixth arrangement).

A battery case with such a shape has smooth curved sides without a corner, meaning a smaller pull force at an end when the battery case bulges than in a hexahedral battery case. This means a smaller force acting on a cleavage groove, which in turn means a smaller opening resulting from cleaving of a straight line-shaped cleavage groove. In contrast, the cleavage groove shaped as in the first arrangement will result in a larger opening produced when the cleavage groove cleaves up than in conventional arrangements.

A sealed battery according to an embodiment of the present invention includes a cleavage groove on a side of the battery case so as to form a cleavage line that intersects a ridge line and includes a first curved segment and a second curved segment curved to protrude in a direction forming an angle of 90 degrees or larger as viewed in a side view, the first and second curved segments being connected with each other. This will provide an arrangement of a cleavage groove that is less likely to cleave up due to an impact if the battery falls, for example, and still can cleave up safely and easily in response to a certain pressure in the battery case.

### BRIEF DESCRIPTION OF THE DRAWINGS

FIG. 1 is a schematic perspective view of a sealed battery according to Embodiment 1 of the present invention.

FIG. 2 is a cross-sectional view of the battery taken on line II-II of FIG. 1.

FIG. 3 is a schematic side view of the sealed battery according to Embodiment 1.

FIG. 4 is a perspective view illustrating the sealed battery of Embodiment 1 during venting.

FIG. 5 is a cross-sectional view of the battery case taken on line V-V of FIG. 4.

FIG. 6 illustrates part of a calculation model of an S-shaped cleavage line.

FIG. 7 illustrates part of a calculation model of a straight cleavage line.

FIG. 8 illustrates part of a calculation model of an arc-shaped cleavage line.

FIG. 9 is a graph showing the remaining thickness of the cleavage groove versus the venting pressure as obtained by calculation and by experiment.

FIG. 10 is a graph showing the results of calculation of venting pressure for various cleavage line shapes.

FIG. 11 is a schematic side view of a sealed battery with a cleavage groove adjacent the bottom of the flat side.

FIG. 12 is a view of a sealed battery according to Variation 1 of Embodiment 1, depicted similarly to FIG. 3.

FIG. 13 is a schematic side view of a sealed battery according to Embodiment 2.

FIG. 14 is a view of a sealed battery according to Embodiment 2, depicted similarly to FIG. 4.

FIG. 15 a schematic side view of a sealed battery according to another embodiment.

FIG. 16 a schematic side view of a sealed battery according to still another embodiment.

FIG. 17 a schematic side view of a sealed battery according to yet another embodiment.

### EMBODIMENTS FOR CARRYING OUT THE INVENTION

Embodiments of the present invention will be described in detail with reference to the drawings. The same or corresponding components in the drawings are labeled with the same characters, and their description will not be repeated.

### Embodiment 1

### Overall Arrangement

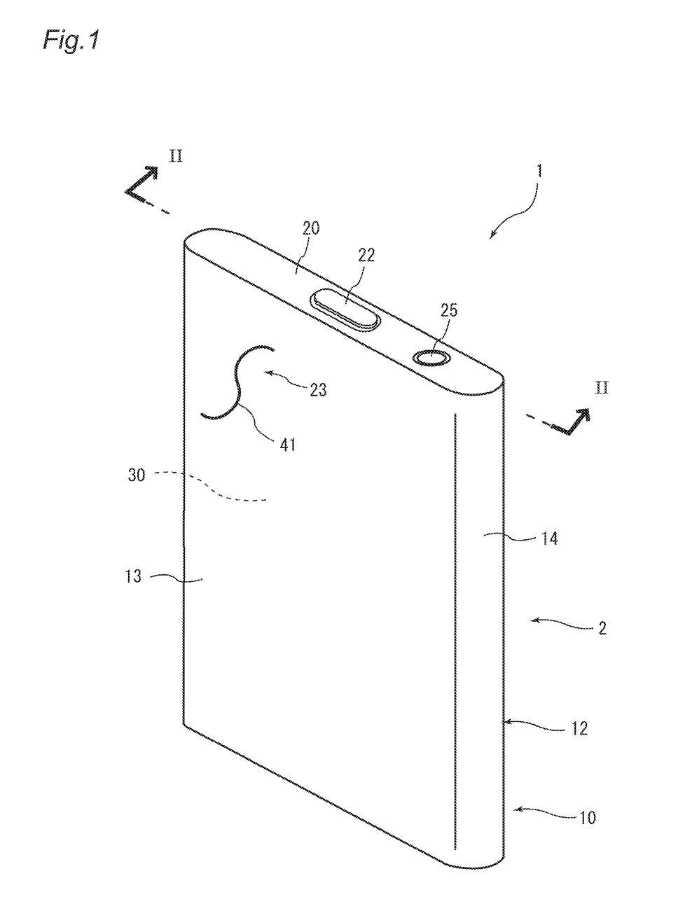

FIG. 1 is a schematic perspective view of a sealed battery 1 according to Embodiment 1 of the present invention. The sealed battery 1 includes: an exterior can 10 in the form of a column with a bottom; a cap 20 that covers the opening of the exterior can 10; and an electrode assembly 30 contained in the exterior can 10. The exterior can 10 together with the attached cap 20 forms a columnar battery case 2 with a space inside. It should be noted that, in addition to the electrode assembly 30, non-aqueous electrolyte (hereinafter referred to as “electrolyte”), is enclosed in the battery case 2.

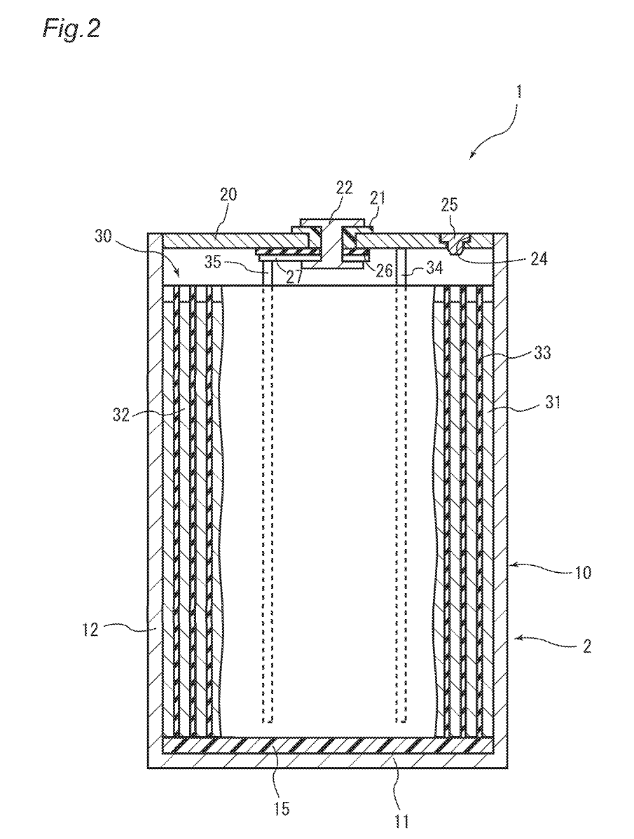

As shown in FIG. 2, the electrode assembly 30 is a jellyroll electrode assembly formed of a stacked and spirally wound sheet-shaped positive electrode 31 and negative electrode 32, where a separator 33 is placed between the two electrodes and one below the negative electrode 32, for example. The positive electrode 31, negative electrode 32 and separator 33 are all stacked upon one another and spirally wound before being pressed to form a flattened electrode assembly 30.

FIG. 2 only shows a few outer layers of the electrode assembly 30. An illustration of an inner portion of the electrode assembly 30 is omitted in FIG. 2; of course, the positive electrode 31, negative electrode 32 and separator 33 exist in the inner portion of the electrode assembly 30. Also, an illustration of an insulator or the like located in a space within the battery and near the cap 20 is omitted in FIG. 2.

The positive electrode 31 includes a positive current collector made of metal foil, such as aluminum foil, having a positive electrode active material layer containing positive electrode active material provided on both sides of the positive current collector. Specifically, the positive electrode 31 is fabricated by applying a positive electrode mixture containing a positive electrode active material, a conductive aid, a binder and the like to the positive current collector of aluminum foil or the like, the positive electrode active material being a lithium-containing oxide that can occlude and discharge lithium ions, and drying the applied materials. Preferably, lithium-containing oxides used as a positive electrode active material may include, for example, a lithium cobalt oxide such as LiCoO₂, a lithium manganese oxide such as LiMn₂O₄, or a lithium composite oxide including a lithium nickel oxide, such as LiNiO₂. It should be noted that just one positive electrode active material may be used, or two or more materials may be combined. Moreover, the positive electrode active materials are not limited to those mentioned above.

The negative electrode 32 includes a negative current collector made of metal foil, such as copper foil, having a negative electrode active material layer containing a negative electrode active material provided on both sides of the negative current collector. Specifically, the negative electrode 32 is fabricated by applying a negative electrode mixture containing a negative electrode active material, a conductive aid, a binder and the like to the negative current collector of copper foil or the like, the negative electrode active material being capable of occluding and discharging lithium ions, and drying the applied materials. Preferably, negative electrode active materials may include, for example, a carbon material that is capable of occluding and discharging lithium ions (graphites, pyrolytic carbons, cokes, glass-like carbons or the like). The negative electrode active materials are not limited to those mentioned above.

The positive electrode 31 of the electrode assembly 30 is connected with a positive lead 34, while the negative electrode 32 is connected with a negative lead 35. The positive and negative leads 34 and 35 extend to the outside of the electrode assembly 30. An end of the positive lead 34 is connected to the cap 20. An end of the negative lead 35 is connected to the negative terminal 22 via a lead plate 27, as described later.

The exterior can 10 is in the form of a column with a bottom made of an aluminum alloy and, together with the cap 20, forms the battery case 2. As shown in FIG. 1, the exterior can 10 is in the form of a column with a bottom having a rectangular bottom 11 with arc-like short sides. More specifically, the exterior can 10 includes a bottom 11 and a flattened and cylindrical side wall 12 having a smooth and rounded surface. The side wall 12 includes a pair of opposite flat sections 13 (sides) and a pair of semi-cylindrical sections 14 connecting the flat sections 13. The exterior can 10 is in a flattened shape where the thickness, which corresponds to the dimension of the short sides of the bottom 11, is smaller than the width, which corresponds to the dimension of the long sides of the bottom 11 (for example, the thickness may be about one tenth of the width). Moreover, the exterior can 10 is joined to the cap 20 which is in turn connected to the positive lead 34, as described later, and thus also serves as a positive electrode terminal of the sealed battery 1.

As shown in FIG. 2, on the inside of the bottom of the exterior can 10 is placed an insulator 15 made of a polyethylene sheet for preventing a short circuit between the positive electrode 31 and the negative electrode 32 of the electrode assembly 30 via the exterior can 10. The electrode assembly 30 described above is positioned in such a way that one of its ends is on the insulator 15.

The cap 20 is joined to the opening of the exterior can 10 with welding to cover the opening of the exterior can 10. The cap 20 is made of an aluminum alloy, similar to the exterior can 10, and has arc-like short sides of the rectangle such that it can fit with the inside of the opening of the exterior can 10. Further, the cap 20 has a through-hole in the center in its longitudinal direction. Through this through-hole pass an insulating packing 21 made of polypropylene and a negative terminal 22 made of stainless steel. Specifically, a generally cylindrical insulating packing 21 penetrated by a generally columnar negative terminal 22 fits with the periphery of the through-hole. The negative terminal 22 has flat portions integrally formed with the respective ends of the columnar axle. The negative terminal 22 is positioned relative to the insulating packing 21 such that a flat portion is exposed to the outside while the axle is inside the insulating packing 21. The negative terminal 22 is connected with a lead plate 27 made of stainless steel. Thus, the negative terminal 22 is electrically connected with the negative electrode 32 of the electrode assembly 30 via the lead plate 27 and the negative lead 35. An insulator 26 is placed between the lead plate 27 and the cap 20.

A fill port 24 for electrolyte is formed on the cap 20 next to the negative terminal 22. The fill port 24 is generally in the form of a circle in a plan view. The fill port 24 has a portion with a small radius and a portion with a large radius, where the radius changes in two steps as it goes in a thickness direction of the cap 20. The fill port 24 is sealed with a seal plug 25 formed in steps corresponding to the different radii of the fill port 24. The outer perimeter of the bottom of the portion with a large radius of the seal plug 25 is laser-welded to the perimeter of the fill port 24 to prevent a gap from being produced between the seal plug 25 and the perimeter of the fill port 24.

### Vent

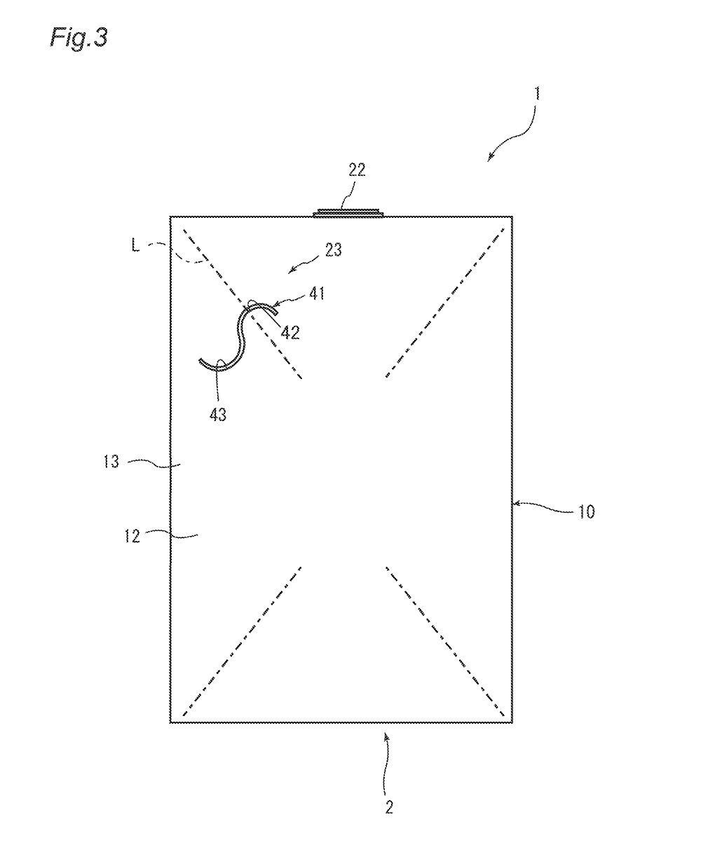

As shown in FIGS. 1 and 3, a cleavage groove 41 that constitutes a vent 23 is formed on a side of the exterior can 10. More particularly, a cleavage groove 41 that forms a generally S-shaped cleavage line is formed on a flat section 13, i.e. a portion of the side wall 12 of the exterior can 10 that extends in a width direction of the sealed battery 1. This cleavage groove 41 is configured to cleave up when the pressure in the battery case 2 exceeds a threshold.

The cleavage groove 41 has a first curved segment 42 curved to protrude outward along the side (i.e. in one direction) as in a side view of the exterior can 10, and a second curved segment 43 curved to protrude inward along the side, i.e. in a direction opposite the outward direction. In this embodiment, the direction in which the first curved segment 42 protrudes (i.e. the direction in which the projection protrudes; the same shall apply hereinafter) and the direction in which the second curved segment 43 protrudes are at an angle of 180 degrees. The cleavage groove 41 forms a generally S-shaped cleavage line, as discussed above, where one end of the first curved segment 42 is connected with one end of the second curved segment 43. In other words, the cleavage line formed by the cleavage groove 41 is made up exclusively of a curved line. In the present embodiment, each of the first and second curved segments 42 and 43 is a semicircle with generally the same radius.

As the cleavage groove 41 is generally in an S-shape with the first curved segment 42 and second curved segment 43, as discussed above, the groove can cleave up in response to a certain pressure in the battery case 2 more easily than a straight or arc-shaped cleavage line, as discussed below in more detail.

Further, since the cleavage groove 41 is generally S-shaped, the cleavage groove 41 may be formed in a smaller area than a straight or arc-shaped cleavage groove with the same length. Particularly, if the cleavage groove forms a straight line, the cleavage groove may cleave up in one stroke if there is an external impact in a direction of an extension of this straight line, while the above configuration will prevent the groove from cleaving up from an external impact in a particular direction. Thus, the cleavage groove 41 is unlikely to cleave up even when an impact is given to the battery case 2 following a fall or the like.

Further, in the present embodiment, portions of the flat section have a smaller thickness than other portions of the flat section 13 and thus form the cleavage groove 41. For example, the cleavage groove 41 is formed by pressing together with the exterior can 10 when the exterior can 10 is press-formed. Pressing causes work hardening in the portions of the flat section that surround the cleavage groove 41, which will improve the strength of the portions of the flat section surrounding the cleavage groove 41. Thus, even when an impact is given to the sealed battery 1 following a fall or the like, the cleavage groove 41 may be prevented from cleaving up due to the impact.

As shown in FIG. 3, the cleavage groove 41 is provided on one of the ridge lines L formed on the exterior can 10 when the battery case 2 swells up due to an increase in interior pressure caused by an interior short circuit, for example, of the sealed battery 1. More specifically, in the present embodiment, the cleavage groove 41 is provided on the flat section 13 of the exterior can 10 such that the first curved segment 42 intersects the ridge line L. In addition, the cleavage groove 41 is provided on the flat section 13 such that the first curved segment 42 is curved to protrude toward a corner (edge) of the battery case 2 located at the base end of the ridge line L.

A ridge line L is formed as the battery case 2 swells up, causing portions of the flat section 13 of the exterior can 10 to bulge, drawn by peripheral portions of the battery case 2 (i.e. the four corners in a battery case 2 shaped as in the present embodiment). Thus, as shown in FIG. 3, ridge lines L extend inwardly from the four corners of the battery case 2 as in a side view of the battery case 2. In FIG. 3, straight ridge lines L extending inwardly from the four corners of the battery case 2 are formed; however, since the ridge lines are formed of bulging portions of the flat section 13 of the exterior can 10 formed when the battery case 2 swells up, as discussed above, the ridge lines L may be curved in shape, and some ridge lines L may be connected with each other.

A ridge line L is a portion of the exterior can 10 that receives large stresses when the battery case 2 swells up; as such, as discussed above, a cleavage groove 41 may be provided to intersect a ridge line L such that the cleavage groove 41 may easily cleave up as the exterior can 10 is deformed. More specifically, as the battery case 2 swells up, the flat section 13 of the exterior can 10 is drawn along ridge lines L such that the cleavage groove 41, which is a portion of the flat section 13 that has a smaller strength, cleaves up.

Particularly, as discussed above, the cleavage groove 41 may be provided on the flat section 13 in such a way that the first curved segment 42 is curved to protrude toward a corner of the battery case 2 located at the base end of a ridge line L such that the protrusion of the first curved segment 42 is located closer to the corner of the battery case 2. A ridge line L is generated beginning from a portion of the battery case 2 near a corner as the battery case 2 is deformed, and thus the first curved segment 42 located on a ridge line L can cleave up relatively early during deformation of the battery case 2.

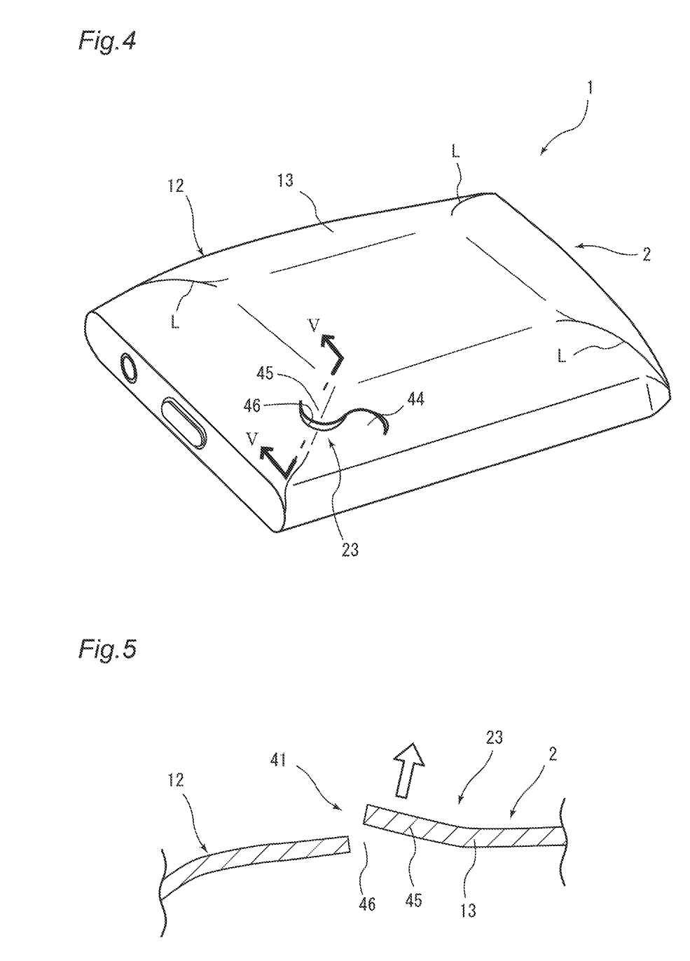

Thus, once a cleavage is generated at a portion of the cleavage groove 41 where the groove intersects a ridge line L, the cleavage advances along the cleavage groove 41. Thus, the entire cleavage groove 41 cleaves up. As the cleavage groove 41 cleaves up, semicircular tongues 44 and 45 are formed, as shown in FIG. 4.

More specifically, when the pressure in the battery case 2 exceeds a threshold and the battery case 2 is deformed to cause the cleavage groove 41 to cleave up, the first curved segment 42 and second curved segment 43 of the cleavage groove 41 form tongues 44 and 45, respectively, as shown in FIG. 4. In other words, the tongues 44 and 45 are shaped according to the shape of the first curved segment 42 and second curved segment 43 of the cleavage groove 41 (i.e. semicircular in the present embodiment).

At this time, as shown in FIG. 5, the tongues 44 and 45 of the flat section 13 of the exterior can 10 are floating above other portions of the flat section 13 as the cleavage groove 41 cleaves up, thereby forming a gap 46. More specifically, when the cleavage groove 41 cleaves up and the flat section 13 of the exterior can 10 is slit up, portions of the flat section 13 along the ridge line L are drawn toward the corner of the exterior can 10 in such a way that portions closer to the corner are drawn outwardly to raise the tongues 44 and 45 relative to other portions of the side wall 12 (indicated by the hollow arrow in the drawing). The gap 46, formed between these tongues 44 and 45 and other portions of the flat section 13, releases gas or the like accumulated in the battery case 2 to the outside. In other words, portions of the flat section 13 that have the cleavage groove 41 serve as a vent 23.

In such a configuration, as the tongues 44 and 45 are raised, a cleavage forms an opening area larger than in implementations with a straight cleavage line, allowing gas or the like in the battery case 2 to be effectively released to the outside.

Moreover, the tongues 44 and 45 formed by the cleavage of the cleavage groove 41 protrude outward with respect to the battery case 2, preventing the tongues 44 and 45 from getting in contact with the electrode assembly 30 in the battery case 2, which would cause a short circuit.

In addition, in such a configuration, the size of the tongues formed by a cleavage is smaller than in implementations with a cleavage groove in a semicircular cleavage line with the same length as the cleavage groove 41, preventing the tongues from damaging an exterior film (not shown) covering the side wall 12 of the battery case 2.

### Effects of Different Vent Shapes

Next, effects of a cleavage groove 41 in a generally S-shaped cleavage line will be described using calculation results and other data. For comparison, calculations are provided for cleavage grooves with other cleavage lines shapes.

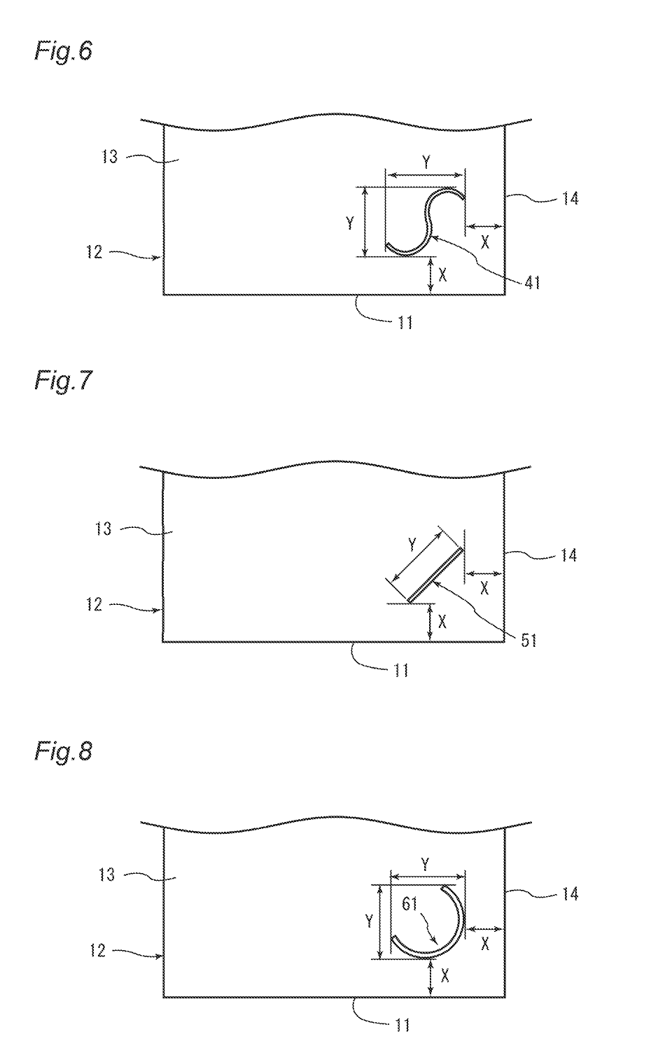

FIGS. 6 to 8 schematically show portions of models used in the calculations. FIG. 6 shows a calculation model having a cleavage groove 41 in a generally S-shaped cleavage line. FIG. 7 shows a calculation model having a cleavage groove 51 in a straight cleavage line. FIG. 8 shows a calculation model having a cleavage groove 61 in an arc-shaped cleavage line. As shown in FIGS. 6 to 8, in the following calculations, the cleavage grooves 41, 51 and 61 are spaced apart from the bottom 11 and semi-cylindrical section 14 as measured on the flat section 13 of the battery case 2 with the same distance (X in the drawings).

The vertical dimension, as measured in the drawing, of the generally S-shaped cleavage groove 41 and arc-shaped cleavage groove 61 is generally the same as the horizontal dimension thereof (Y in the drawings), and the vertical and horizontal dimensions of the cleavage groove 41 are generally the same as those of the cleavage groove 61. The length of the direct line-shaped cleavage groove 51 (Y in the drawing) is generally the same as the vertical and horizontal dimensions of the generally S-shaped cleavage groove 41 and arc-shaped cleavage groove 61.

The calculations below used structural analysis software called LS-DYNA (Registered Trademark). In the calculations, the following equation for determining ductile fracture was used to determine whether the cleavage groove cleaved up (i.e. whether the battery was vented):

$$I = \frac{{1}^{ɛ}}{b} {{\int }_{0}}^{1} ( \frac{{σ}_{m}}{σ} + a ) d ɛ \qquad [ Eq . 1 ]$$

Here, a and b are material parameters calculated from results of material tests; and σₘ represents average stress, σ equivalent stress, ε equivalent strain, and dc increment in equivalent strain.

It will be assumed that rupturing begins at the cleavage groove when I exceeds 1 in the above equation, and the pressure in the battery case at that time will be referred to as venting pressure. In the present calculations, a is 0.3 and b is 0.14.

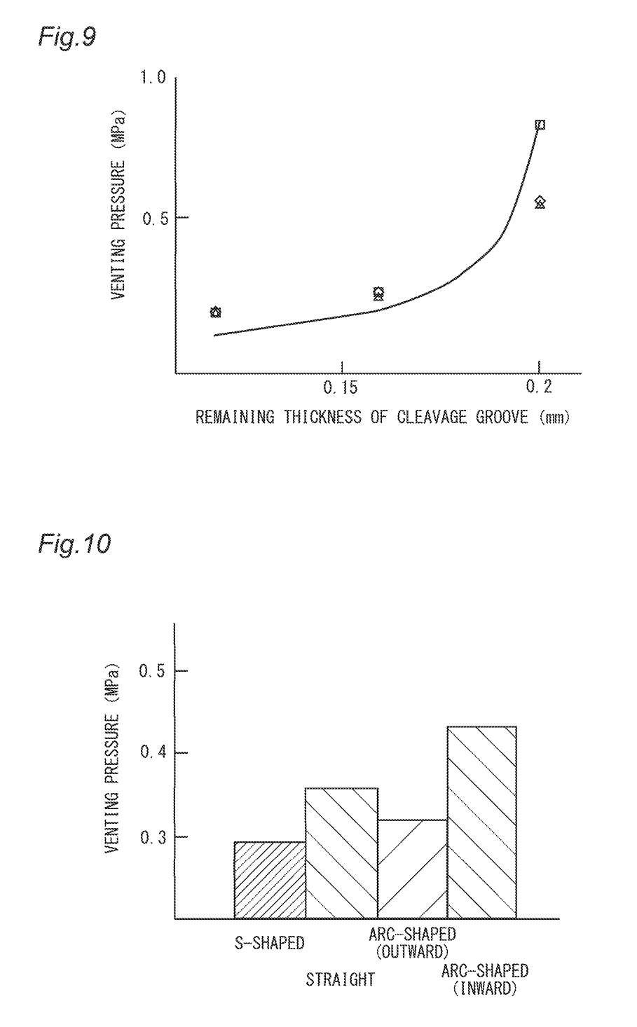

First, to determine whether the above-described calculation method used herein is appropriate, comparisons were made, in an implementation with a straight line-shaped cleavage groove 51 as shown in FIG. 7, between values obtained by the above calculation method (i.e. calculation results) and values measured when a cleavage groove actually cleaved up (i.e. measurement results). The results of the comparisons are shown in FIG. 9. FIG. 9 shows measurement results for venting pressure of the cleavage groove with varying remaining thickness of the cleavage groove (indicated by triangles, squares and lozenges in the drawing) and calculation results (indicated by the solid line in the drawing). The battery case had a width of 51 mm, a height of 47 mm and a thickness of 5.1 mm, and a case wall thickness of 0.3 mm. To actually cause the cleavage groove to cleave up, air was injected into the battery case until the cleavage groove cleaved up, and the pressure in the battery case measured when the groove cleaved up will be referred to as venting pressure.

As shown in FIG. 9, the measurement results and calculation results for venting pressure substantially match, and the calculations simulate the tendency of the measurement results for the venting pressure of the cleavage groove to rapidly increase with a remaining thicknesses of the cleavage groove larger than 0.2 mm. Since, therefore, the calculation method used is capable of simulating actual situations, the venting pressures of the cleavage grooves 41, 51 and 61 of FIGS. 6 to 8 will be estimated by calculation.

FIG. 10 shows calculation results for venting pressure for S-shaped (FIG. 6), straight (FIG. 7) and arc-shaped (FIG. 8) cleavage lines. The results shown in FIG. 10 are from calculations where X is 5 mm and Y is 10 mm in FIGS. 6 to 8. Also, FIG. 10 shows calculation results for an arc-shaped cleavage line curved to protrude outward on the flat section 13 of the battery case 2, as shown in FIG. 8 (“outward” in FIG. 10) and a cleavage line curved to protrude inward on the flat section 13 of the battery case 2 (“inward” in FIG. 10). The battery case had a width of 51 mm, a height of 47 mm and a thickness of 5.1 mm, and a case wall thickness of 0.3 mm.

As shown in FIG. 10, the S-shaped cleavage line of the present embodiment has a venting pressure lower than that of the straight and arc-shaped cleavage lines. Thus, the S-shaped cleavage line of the present embodiment is more likely to cleave up in response to a certain pressure in the battery case than the straight or arc-shaped cleavage line.

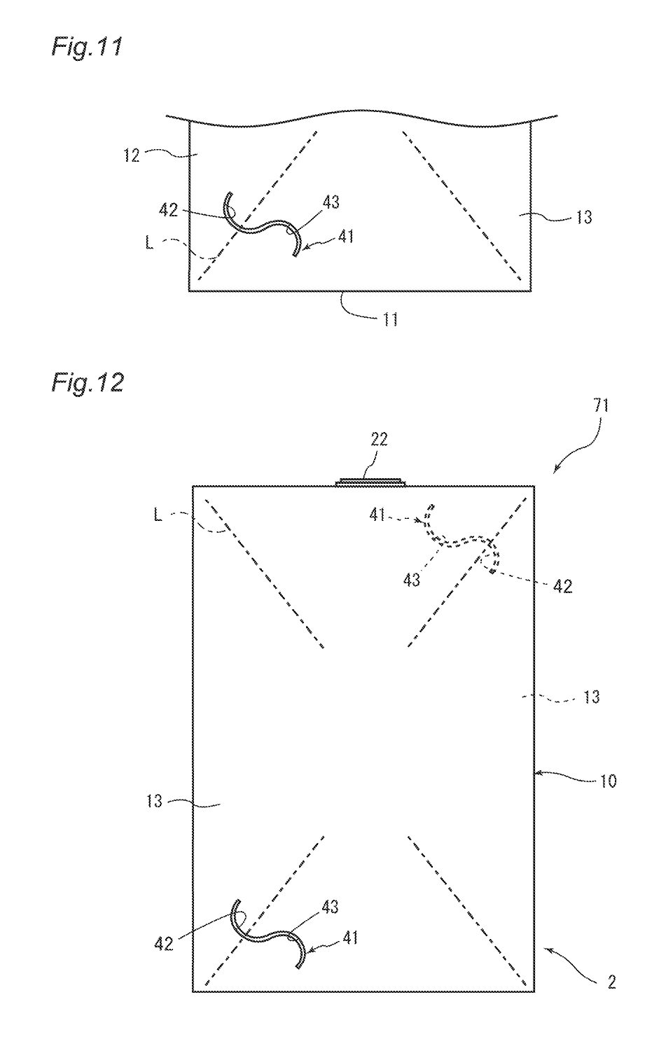

In the present embodiment, the cleavage groove 41 is provided on the flat section 13 of the battery case 2 and located adjacent the cap 20; alternatively, as shown in FIG. 11, the groove may be provided on the flat section 13 of the battery case 2 and located adjacent the bottom 11. Further, in the present embodiment, the cleavage groove 41 is located to the left as viewed in a direction normal to the flat section 13; alternatively, the groove may be located to the right.

### Effects of Embodiment 1

Thus, in the present embodiment, a cleavage groove 41 is provided on a flat section 13 of a battery case 2 of a sealed battery 1, having a first curved segment 42 curved to protrude in one direction as viewed in a side view and a second curved segment 43 curved to protrude in a direction opposite that one direction. This cleavage groove 41 is provided on the flat section 13 such that the first curved segment 42 is located on a ridge line L on the flat section 13. Thus, a generally S-shaped cleavage line is formed by the cleavage groove 41 on the flat section 13. As a generally S-shaped cleavage line is provided on the flat section 13 of the battery case 2, the cleavage groove 41 is more likely to cleave up in response to a certain pressure in the battery case 2 than in implementations with a straight or arc-shaped cleavage line. Thus, the above arrangement will improve the functionality of a vent.

Further, as a generally S-shaped cleavage line is provided on the flat section 13 of the battery case 2, the cleavage groove 41 is less likely to cleave up when an impact is given to the battery case 2 if the sealed battery 1 falls, for example.

Further, as the cleavage groove 41 is provided on the flat section 13 such that the first curved segment 42 is curved to protrude toward the corner of the battery case 2 that is located at the base end of the ridge line L, the cleavage groove 41 may cleave up early during deformation of the battery case 2. This will allow the cleavage groove 41 to cleave up in a more reliable manner.

Furthermore, in the case of the above arrangement, a larger gap 46 will be formed when the cleavage groove 41 cleaves up than in implementations with a straight line-shaped cleavage groove 41, allowing gas or the like to be released effectively from inside the battery case 2 of the sealed battery 1 to the outside.

Further, in the case of the above arrangement, the tongues 44 and 45 formed when the cleavage groove 41 cleaves up protrude outward with respect to the battery case 2, thereby preventing the tongues 44 and 45 from getting in contact with the electrode assembly 30 in the battery case 2 to cause a short circuit. Moreover, as a cleavage groove 41 is provided so as to form a generally S-shaped cleavage line, the tongues formed when the cleavage groove cleaves up may be smaller than in implementations with a cleavage groove forming an arc-shaped cleavage line. Thus, the above arrangement is less likely to damage the exterior film covering the battery case than arrangements with an arc-shaped cleavage line.

The battery case 2 of the sealed battery 1 of the present embodiment has the shape of a column with a rectangular bottom surface with arc-like short sides, which means a smaller pull force at the corners when the battery case bulges than in a hexahedral battery case. Still, as the cleavage groove 41 is configured as illustrated above, the cleavage groove 41 may easily cleave up.

### Variation 1 of Embodiment 1

FIG. 12 schematically shows a sealed battery 71 according to Variation 1 of Embodiment 1. The arrangement of Variation 1 is different from that of Embodiment 1 in that one cleavage groove 41 is provided on each of the two flat sections 13 of the battery case 2. In the description below, the same components as in the embodiment are labeled with the same characters and their description will not be given, and only the different components will be described.

As shown in FIG. 12, a cleavage groove 41 (indicated by solid lines in the drawing) is provided on one flat section 13 of the two flat sections 13 of the battery case 2 (i.e. the flat section 13 closer to a person viewing the drawing) and is located adjacent the bottom of the flat section 13 (i.e. adjacent one of the edges of the battery disposed in an axial direction of the battery) and to the left as viewed in a direction normal to the flat section 13 (i.e. adjacent one of the edges of the battery disposed in a width direction of the battery). Another cleavage groove 41 (indicated by broken lines in the drawing) is provided on the other flat section 13 (i.e. the flat section 13 farther from a person viewing the drawing) and is located adjacent the cap 20 of the flat section 13 (i.e. adjacent the other one of the edges of the battery disposed in an axial direction of the battery) and to the right as viewed in a direction normal to the flat section 13 (i.e. adjacent the other one of the edges of the battery disposed in a width direction of the battery). That is, in the battery case 2, one cleavage groove 41 is provided on one flat section 13 while another cleavage groove 41 is provided on the other flat section 13 and is in the opposite location in left-right and top-bottom relationships as viewed in a direction normal to the flat section 13.

Each cleavage groove 41 is provided on the flat section 13 such that the first curved segment 42 is located on a ridge line L and protrudes toward the corner of the battery case 2 located at the base end of the ridge line L.

Thus, as shown in FIG. 12, in the present variation, the cleavage grooves 41, provided on the two flat sections 13, are each located adjacent the cap 20 or bottom 11 of the battery case 2 as viewed in a direction normal to a flat section 13 of the battery case 2 and each intersect a ridge line L located to the left or right with respect to the battery case. Thus, even if there are variations in the deformation of the two flat sections 13, caused by differences in the strength of the portions of the battery case 2 that are adjacent the cap 20 and bottom 11 as well as differences in the strength of the portions of the battery case 2 as measured in a width direction of the case, for example, one of the two cleavage grooves 41 may cleave up, thereby ensuring the functioning of a vent.

In FIG. 12, a cleavage groove 41 is located adjacent the bottom 11 and to the left on one flat section 13, while another cleavage groove 41 is located adjacent the cap 20 and to the right on the other flat section 13. Alternatively, a cleavage groove 41 may be located adjacent the bottom 11 and to the right on one flat section 13 and another cleavage groove 41 may be located adjacent the cap 20 and to the left on the other flat section 13.

### Embodiment 2

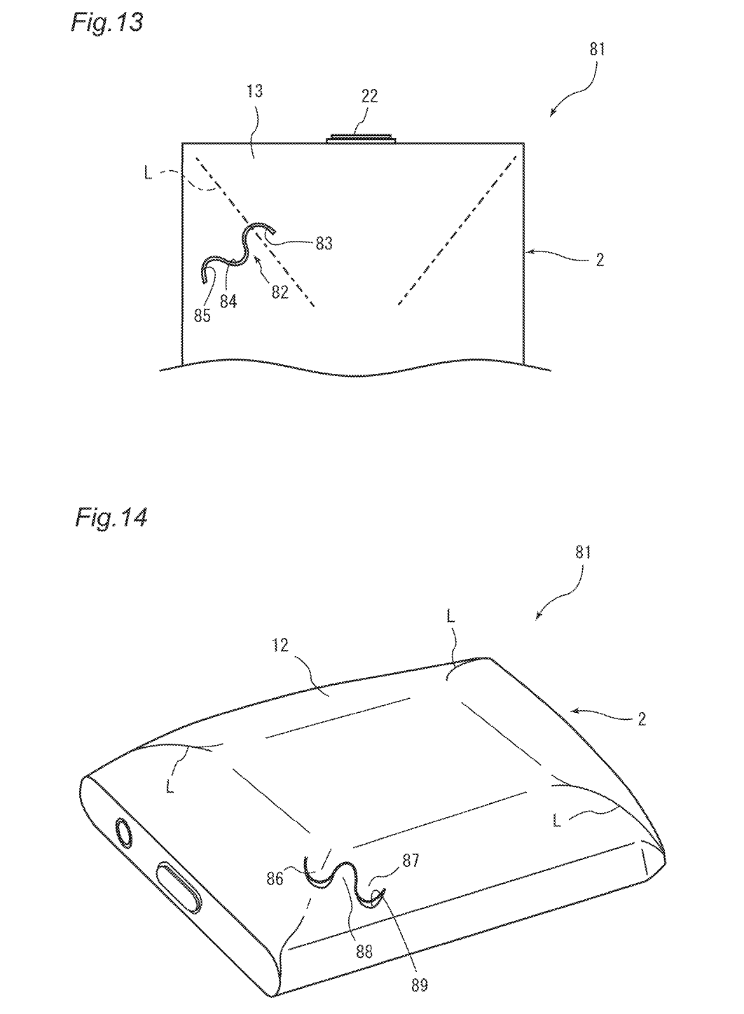

FIG. 13 schematically shows a sealed battery 81 according to Embodiment 2. The present embodiment is different from Embodiment 1 in that a cleavage groove 82 provided on the battery case 2 of the sealed battery 81 includes three curved segments 83 to 85. In the description below, the components having the same configuration and function as in Embodiment 1 are labeled with the same characters as in Embodiment 1 and no description thereof will be given.

More specifically, the cleavage groove 82 includes first and third curved segments 83 and 85 curved to protrude outward along the side (or in one direction) as viewed in a side view of the exterior can 10, and a second curved segment 84 curved to protrude inward along the side, i.e. in a direction opposite the outward direction. The cleavage groove 82 is generally M-shaped as a whole, with the first and third curved segments 83 and 85 connected with the ends of the second curved segment 84. Similar to Embodiment 1, in the present embodiment, each of the first to third curved segments 83 to 85 has the shape of a semicircle with generally the same diameter.

The cleavage groove 82 is provided such that the first curved segment 83 is located on a ridge line L. As such, when the pressure in the battery case 2 exceeds a threshold, the first curved segment 83 on the ridge line L cleaves up, followed by the second and third curved segments 84 and 85 cleaving up.

As shown in FIG. 14, when the cleavage groove 82 cleaves up, tongues 86 to 88 are formed by the first to third curved segments 83 to 85.

The tongues 86 to 88 protrude outward with respect to the battery case 2. Thus, a gap 89 is formed where cleaving occurred. Since the tongues 86 to 88 formed by the cleaving of the cleavage groove 82 protrude outward with respect to the battery case 2, the gap 89 has a larger opening area than in implementations with a straight line-shaped cleavage groove. Further, as the tongues 86 to 88 protrude outward with respect to the battery case 2, the cleave-up portions do not get in contact with the interior of the sealed battery 1, thereby preventing a short circuit.

Further, similar to Embodiment 1 illustrated above, the cleavage groove 82 is formed by pressing together with the exterior can 10 when the exterior can 10 is press-formed. Pressing causes work hardening, which will improve the strength of the portions of the flat section surrounding the cleavage groove 82. Thus, even when an impact is given to the sealed battery 1 following a fall or the like, the cleavage groove 82 may be prevented from cleaving up due to the impact.

### Effects of Embodiment 2

In the present embodiment, a generally M-shaped cleavage groove 82 having first to third curved segments 83 to 85 is provided on the flat section 13 of a side wall 12 of the exterior can 10. This will increase the opening area of the cleavage produced when the cleavage groove 82 cleaves up, thereby allowing gas or the like in the battery case 2 from being released effectively to the outside.

### Other Embodiments

While embodiments of the present invention have been illustrated, the above embodiments are merely examples that may be used to carry out the present invention. Thus, the present invention is not limited to the above embodiments, and the above embodiments may be modified as appropriate without departing from the spirit of the invention.

In Embodiment 1 illustrated above, a cleavage groove 41 is provided such that the first curved segment 42 is located on a ridge line L. Alternatively, a cleavage groove 41 may be provided such that the second curved segment 43 is located on a ridge line L.

In Embodiment 2 illustrated above, a cleavage groove 82 is provided such that the first curved segment 83 is located on a ridge line L. Alternatively, a cleavage groove 82 may be provided such that the second or third curved segment 84 or 85 is located on a ridge line L.

Further, the present invention is not limited to the configurations of Embodiments 1 and 2 illustrated above, and the cleavage groove 41 or 82 may be located anywhere on the flat section 13 of the exterior can 10 as long as a portion of the cleavage groove 41 or 82 is located on a ridge line L, and the direction of the cleavage line formed by the cleavage groove 41 or 82 is not limited to the directions in Embodiments 1 and 2 illustrated above.

In Embodiment 1 illustrated above, the cleavage groove 41 has two curved segments 42 and 43, and in Embodiment 2 illustrated above, the cleavage groove 82 has three curved segments 83 to 85. Alternatively, the cleavage groove may have four or more curved segments. In such implementations, the cleavage groove is provided so as to form a cleavage line having curved segments being connected with each other, the curved segments each curved to protrude in a direction opposite that of the adjacent one(s).

In Embodiment 1 illustrated above, the battery case has a width of 51 mm, a height of 47 mm and a thickness of 5.1 mm, and a case wall thickness of 0.3 mm; however, the present invention is not limited to these dimensions, and the battery case may have a width of 20 to 60 mm, a height of 30 to 100 mm and a thickness of 3 to 10 mm, and a wall thickness of 0.15 to 0.5 mm.

In the embodiments illustrated above, the first curved segment 42 or 83 and the second curved segment 43 or 84 and the third curved segment 85 forming the cleavage groove 41 or 82 are arc-shaped with generally the same diameter. However, the curved segments may have different diameters, and may have other shapes, such as portions of ellipses.

In the above embodiments, the cleavage groove 41 or 82 is formed by pressing. Alternatively, the cleavage groove 41 or 82 may be formed by laser machining, cutting or the like.

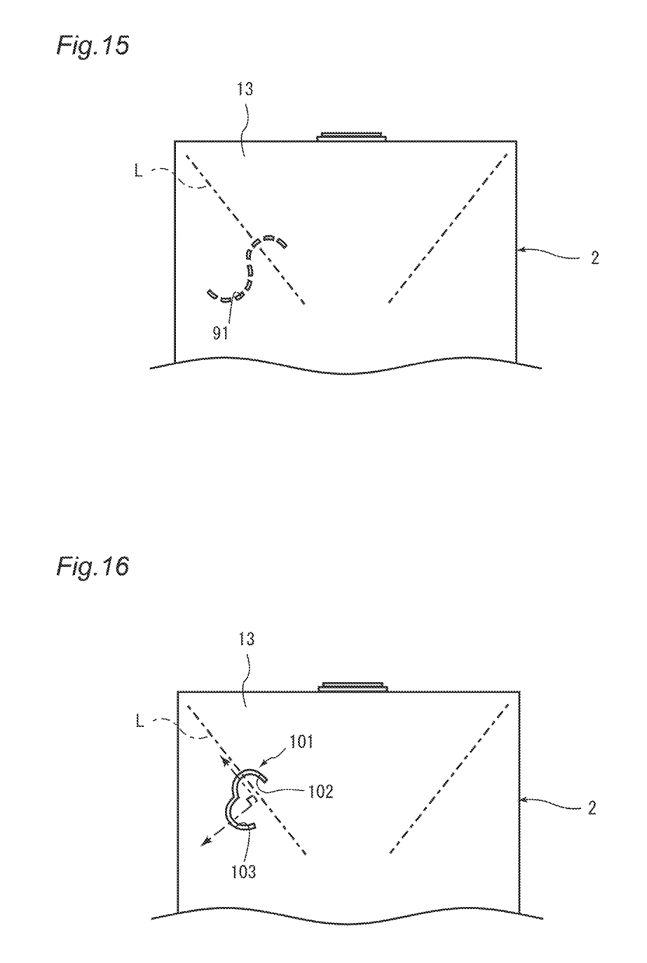

In the above embodiments, the cleavage groove 41 or 82 is formed of a continuous groove. Alternatively, as shown in FIG. 15, the cleavage groove may be divided into a plurality of portions, where several separate groove portions 91 constitute the cleavage groove. In such implementations, the groove portions 91 may be arranged to form the shape of the cleavage groove 41 of FIG. 3. In such arrangements, the groove portions 91 cleave up before the portions between the groove portions 91 cleave up such that the entire cleavage groove cleaves up. That is, since the cleavage groove is not a continuous one, the entire cleavage groove may be prevented from cleaving up even when the sealed battery 1 receives an impact due to a fall or the like. Thus, in this arrangement, the cleavage groove is less likely to cleave up upon an impact following a fall or the like. While FIG. 15 shows a cleavage groove 41 formed by a plurality of groove portions 91, cleavage grooves of other shapes may be formed by a plurality of groove portions.

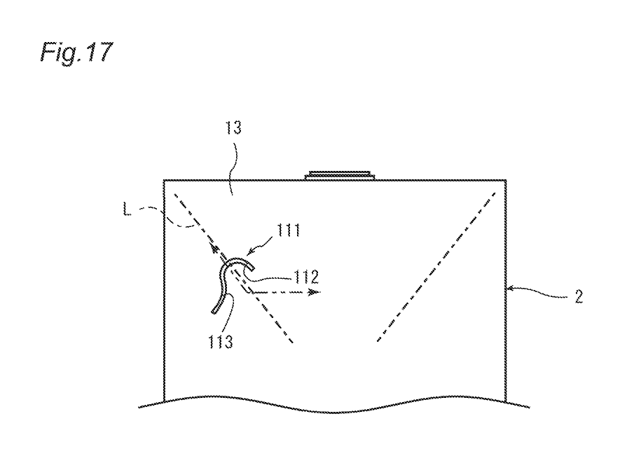

In the above embodiments, the cleavage groove 41 has a first curved segment 42 curved to protrude outward along the side as in a side view of the exterior can 10 and a second curved segment 43 curved to protrude inward along the side, i.e. in a direction opposite the outward direction. However, as shown in FIG. 16, the cleavage groove 101 on the flat section 13 of the battery case 2 may be shaped such that the direction in which the first curved segment 102 protrudes (indicated by an arrow with a two-dot chain line) and the direction in which the second curved segment 103 protrudes (indicated by an arrow with a two-dot chain line) form an angle of about 90 degrees. Further, as shown in FIG. 17, the cleavage groove 111 on the flat section 13 of the battery case 2 may be shaped such that the direction in which the first curved segment 112 protrudes (indicated by an arrow with a two-dot chain line) and the direction in which the second curved segment 113 protrudes (indicated by an arrow with a two-dot chain line) form an angle larger than 90 degrees (135 degrees, for example). In other words, the cleavage groove may be in any shape as long as the direction in which the first curved segment protrudes and the direction in which the second curved segment protrudes form an angle of 90 degrees or larger. More preferably, the direction in which the first curved segment protrudes is generally opposite the direction in which the second curved segment protrudes, that is, the direction in which the second curved segment protrudes forms an angle larger than 90 degrees with the direction in which the first curved segment protrudes.

In the above embodiments, the battery case 2 of the sealed battery 1 is shaped as a column having a rectangular bottom surface with arc-shaped short sides. Alternatively, the battery case may be in other shapes, such as a hexahedron.

In the above embodiments, the sealed battery 1 is a lithium-ion battery. Alternatively, the sealed battery 1 may be a battery other than a lithium-ion battery.

### INDUSTRIAL APPLICABILITY

The present invention is useful in a sealed battery where a cleavage groove is formed on a side of the battery case.

1. A sealed battery comprising a cylindrical battery case configured to encapsulate an electrode assembly and electrolyte,
wherein a side of the battery case includes a cleavage groove forming a cleavage line intersecting a ridge line which is formed on the side of the battery case when the battery case swells up due to an increase in internal pressure,
the cleavage line is, as viewed in a direction normal to the side of the battery case, formed exclusively by a curved line including a first curved segment curved to protrude in one direction and a second curved segment curved to protrude in a direction forming an angle of 90 degrees or larger with the direction in which the first curved segment protrudes,
one end of the first curved segment is connected with one end of the second curved segment, and
at least one of the first curved segment and the second curved segment intersects the ridge line.

2. The sealed battery according to claim 1, wherein the cleavage line is formed of a combination of a single first curved segment and a single second curved segment.

3. The sealed battery according to claim 1, wherein
the first curved segment is curved to protrude toward an edge of the battery case located at a base end of the ridge line intersecting the cleavage line, and
the cleavage groove is formed on the side of the battery case such that the first curved segment is located on the ridge line.

4. The sealed battery according to claim 1, wherein a cleavage groove is provided on each of a pair of opposite sides of the battery case.

5. The sealed battery according to claim 4, wherein
the cleavage line on one of the pair of sides, as viewed in a direction normal to the one side, intersects a ridge line formed on the one side in one of halves of the battery case disposed in a width direction thereof and is located adjacent one of edges of the battery case disposed in an axial direction thereof, and
the cleavage line on the other one of the pair of sides, as viewed in a direction normal to the one side, intersects a ridge line formed on the other side in the other one of the halves of the battery case disposed in a width direction thereof and is located adjacent the other one of the edges of the battery case disposed in an axial direction thereof.

6. The sealed battery according to claim 1,
wherein the battery case is a column having a rectangular bottom surface with an arc-like short side and having a space capable of containing the electrode assembly and the electrolyte.

7. The sealed battery according to claim 4, wherein the battery case is a column having a rectangular bottom surface with an arc-like short side and having a space capable of containing the electrode assembly and the electrolyte.
